(19) United States
(12) Patent Application Publication
(10) Pub. No.: US 2010/0318694 A1
(43) Pub. Date: Dec. 16, 2010

(54) ELECTRONIC DEVICE FOR GENERATING UART SIGNALS AND METHOD THEREOF

(75) Inventor: CHUN-TE WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/564,710

(22) Filed: Sep. 22, 2009

(30) Foreign Application Priority Data
Jun. 11, 2009 (CN) 200910303144.3

(51) Int. Cl. G06F 13/38

(52) U.S. Cl. 710/63

(57) ABSTRACT

An electronic device generates universal asynchronous receiver/transmitter (UART) signals suitable to be transmitted via an audio port of the electronic device. The electronic device comprises a storing module, a reading module, an audio register, a controller and a processor. The store module stores debug or repair data comprising a plurality of bytes. The read module reads the plurality of bytes of the data one by one. The audio register generates a first audio signal and a second audio signal via the audio port. The controller controls the audio register to output the first or second audio signal according to binary numbers of a start bit, eight data bits, a parity bit and a stop bit of the UART signals. The processor executes operations of the storing module, the reading module, the audio register and the controller.

### BACKGROUND

1. Technical Field

Embodiments of the present disclosure relate to electronic devices for generating universal asynchronous receiver/transmitter (UART) signals, and particularly to an electronic device for generating UART signals suitable for transmission via an audio port and a method thereof.

2. Description of Related Art

UART ports are commonly used for outputting the UART signals unilaterally, for subsequent conversion to RS-232 signals readable by computers via a signal conversion circuit for debugging and repairing. However, the UART ports may not be included in an electronic device in order to decrease costs during mass production. As a result, it is inconvenient to debug and repair the electronic devices, and has a low production efficiency.

### BRIEF DESCRIPTION OF THE DRAWINGS

Many aspects of the embodiments can be better understood with references to the following drawings, wherein like numerals depict like parts, and wherein:

FIG. 1 is a block diagram of an electronic device of one embodiment of the present disclosure;

FIG. 2 is an exemplary waveforms diagram of UART signals generated by the electronic device of FIG. 1; and

FIG. 3 is a flow diagram of a method of one embodiment of the present disclosure.

### DETAILED DESCRIPTION

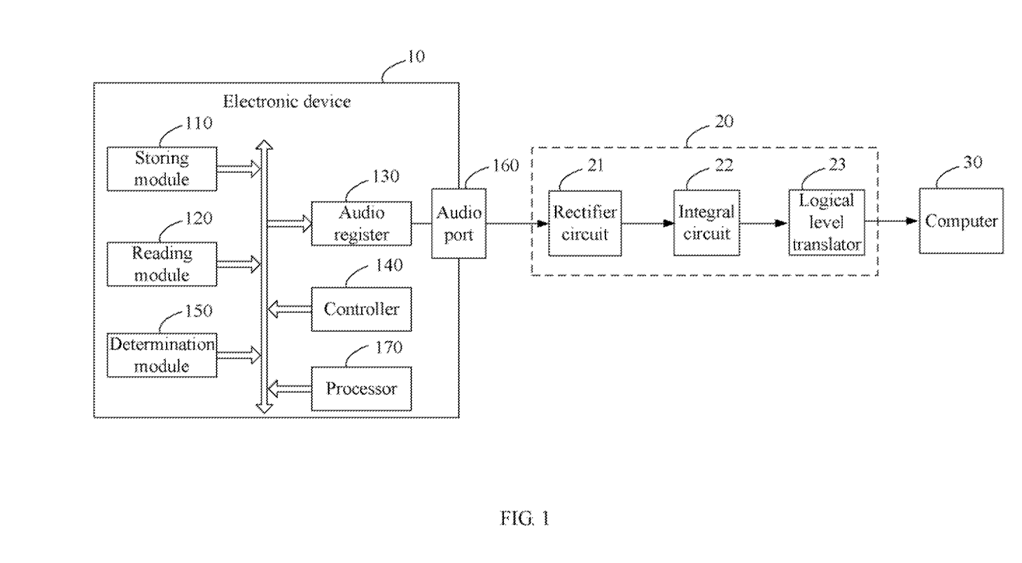

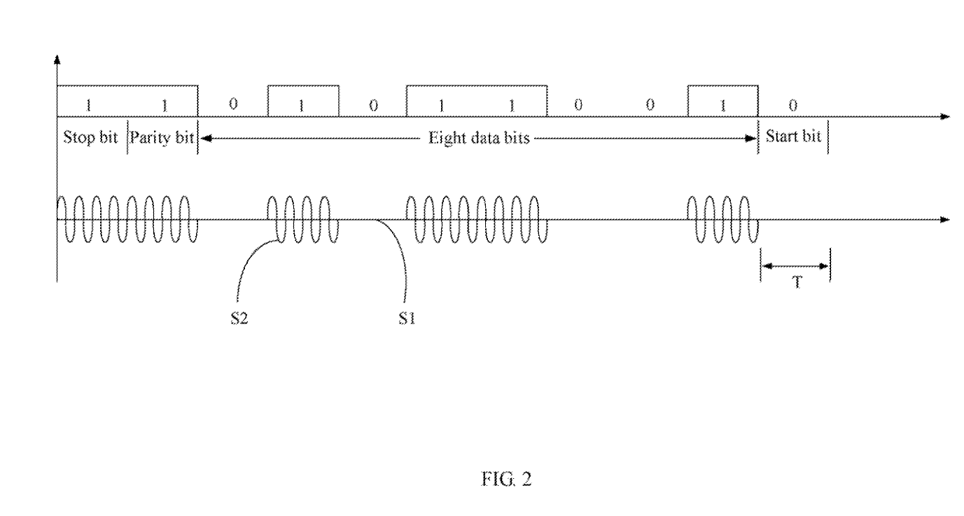

Referring to FIG. 1, a block diagram of an electronic device 10 of one embodiment of the present disclosure is shown. The electronic device 10 converts data to universal asynchronous receiver/transmitter (UART) signals suitable to be transmitted via an audio port 160 of the electronic device 10. In one embodiment, each UART signal comprises a start bit, eight data bits, a parity bit and a stop bit (see FIG. 2). The start bit is always represented by a binary number “0” (logic low). The stop bit is always represented by a binary number “1” (logic high).

The electronic device 10 comprises a storing module 110, a reading module 120, an audio register 130, a controller 140, a determination module 150 and the audio port 160. The modules 110, 120, 130, 140, 150 may comprise one or more computerized operations operable to be executed by a processor 170 of the electronic device 10.

In one embodiment, the storing module 110 stores the data comprising a plurality of bytes. Each byte of the data comprises eight binary numbers. In one embodiment, the data comprises debug or repair data, such as a failure report, a system log of the electronic device 10.

The reading module 120 reads eight binary numbers of each byte of the data to be defined as the eight data bits of a corresponding UART signal, and calculates a parity bit of each byte of the data to be defined as the parity bit of the corresponding UART signal.

The audio register 130 generates a first audio signal S1 and a second audio signal S2 via the audio port 160 to represent the binary numbers 1 and 0 of the UART signals, respectively. In one embodiment, the first audio signal S1 represents the binary number 0, and the second audio signal S2 represents the binary number 1. Exemplary waveforms of the first audio signal S1 and the second audio signal S2 are shown in FIG. 2. A signal period T of the first audio signal S1 or the second audio signal S2 is determined by a baud rate of data transmission. In one embodiment, the baud rate of the data transmission may be 9600 baud per second (Bps), and the signal period T of the first audio signal S1 or the second audio signal S2 is 1/9600 second correspondingly. In other alternative embodiments, the baud rate of the data transmission may be 4800 Bps, and the signal period T of the first audio signal S1 or the second audio signal S2 is 1/4800 second correspondingly.

The controller 140 controls the audio register 130 to output the first audio signal S1 or the second audio signal S2 according to the binary numbers of the start bit, the eight data bits, the parity bit and the stop bit successively, thus the electronic device 10 converts each byte of the data to the UART signal based on the first audio signal S1 and the second audio signal S2.

The determination module 150 determines whether the plurality of bytes of the data are all converted to the UART signals. If there are still some bytes of the data in the storing module 110 have not been converted to the UART signals, the reading module 120 reads the remaining data.

A signal converting circuit 20 receives the UART signals based on the first audio signal S1 and the second audio signal S2 output by the audio port 160 of the electronic device 10, and then converts the UART signals to RS-232 signals. In one embodiment, the signal converting circuit 20 comprises a rectifier circuit 21, an integral circuit 22 and a logic level translator 23. A computer 30 receives and reads the RS-232 signals output by the signal converting circuit 20 for debugging and repairing.

Referring to FIG. 2, an exemplary waveforms diagram of the UART signals output by the audio port 160 of the electronic device 10 is shown. In one embodiment, an UART signal converted from a byte 10011010 is illustrated for better understanding the embodiments of the present disclosure in FIG. 2. From right to left in sequence, the first bit is the start bit of the UART signal, from the second bit to the ninth bit are the eight data bits of the UART signal, the tenth bit is the parity bit of the UART signal and the last bit is the stop bit of the UART signal.

In one embodiment, the start bit of the UART signal is represented by the binary number 0, and the controller 140 controls the audio register 130 to output the first audio signal S1 accordingly.

The eight data bits of the UART signal are represented by the eight binary numbers of the byte 10011010. If one of the eight binary numbers of the byte is 0, the controller 140 controls the audio register 130 to output the first signal S1 accordingly. If another one of the eight binary numbers of the byte is 1, the controller 140 controls the audio register 130 to output the second audio signal S2 accordingly. Thus, the controller 140 controls the audio register 130 to output the first audio signal S1 or the second audio signal S2 according to the eight binary numbers of the byte to represent the eight data bits of the UART signal.

The parity bit of the UART signal is represented by the parity bit of the byte calculated by the reading module 120. If the parity bit of the byte is 1, the controller 140 controls the audio register 130 to output the first audio signal S1 accordingly, and if the parity bit of the byte is 0, the controller 140 controls the audio register 130 to output the second audio signal S2 accordingly.

The stop bit is represented by the binary number 1, and the controller 140 controls the audio register 130 to output the second audio signal S2 accordingly.

In one embodiment, the data in the storing module 110 are converted to the UART signals based on the first audio signal S1 and the second audio signal S2, and then output to the signal converting circuit 20 via the audio port 160. The signal converting circuit 20 converts the UART signals to the RS-232 signals. The computer 30 receives and reads the RS-232 signals for debugging and repairing.

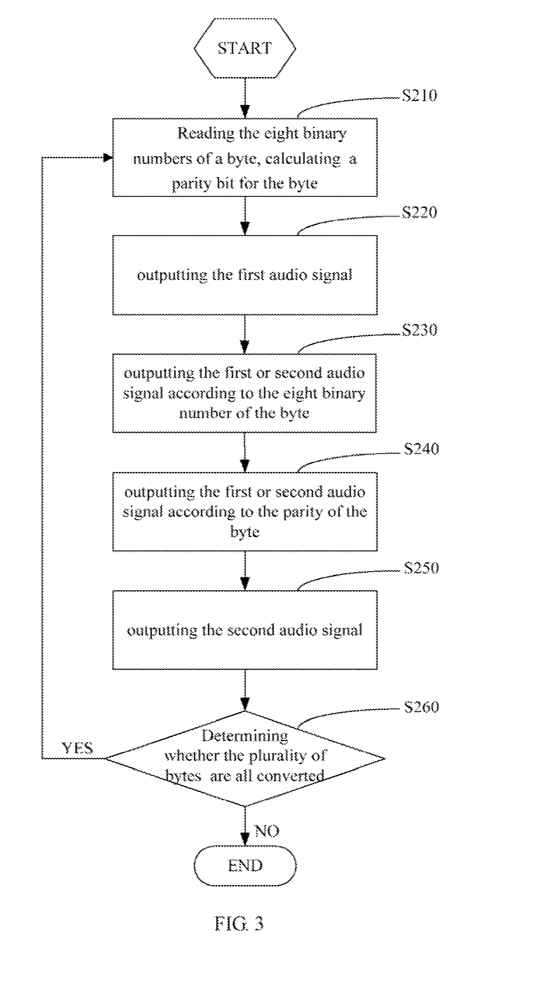

Referring to FIG. 3, an exemplary flow diagram of a method of the present disclosure is shown. The method for generating UART signals via an audio port comprises a plurality of steps as follows:

In step S210, the reading module 120 reads a byte of the data in the storing module 110. The reading module 120 reads the eight binary numbers of the byte to be defined as the eight data bits of an UART signal, and calculates the parity bit of the byte to be defined as the parity bit of the UART signal.

In step S220, the audio register 130 outputs the first audio signal S1 to represent the start bit of the UART signal.

In step S230, the audio register 130 outputs the first audio signal S1 or the second audio signal S2 to represent the eight data bits of the UART signal according to the eight binary numbers of the byte successively. In one embodiment, if one of the eight binary numbers of the byte is 0, the audio register 130 outputs the first audio signal S1 to represent one corresponding data bit of the UART signal; if another one of the eight binary numbers of the byte is 1, the audio register 130 outputs the second audio signal S2 to represent another corresponding data bit of the UART signal.

In step S240, the audio register 130 outputs the first audio signal S1 or the second audio signal S2 to represent the parity bit of the UART signal according to the parity bit of the byte calculated by the reading module 120. In one embodiment, if the parity bit of the byte is 1, the audio register 130 outputs the first audio signal S1 to represent the parity bit of the UART signal; if the parity of the byte is 0, the audio register 130 outputs the second audio signal S2 to represent the parity bit of the UART signal.

In step S250, the audio register 130 outputs the second audio signal S2 to represent the stop bit of the UART signal.

In step S260, the determination module 150 determines whether the plurality of bytes of the data in the storing module 110 are all converted to the UART signals. If there are still some bytes of the data in the storing module 110 have not been converted to the UART signals, the reading module reads the remaining bytes of the data stored in the storing module 110 and repeats the step S210.

It is apparent that the present disclosure provides an electronic device and a method for converting data to UART signals suitable to be transmitted via an audio port. The UART signals are converted to RS-232 signals by the signal converting circuit, and the RS-232 signals are received and read by a computer for debugging and repairing. The electronic device and the method of the present disclosure bring convenience into debugging and repairing of the electronic devices, and increase the production efficiency.

It is believed that the present embodiments and their advantages will be understood from the foregoing description, and it will be apparent that various modifications, alterations and changes may be made thereto without departing from the spirit and scope of the invention or sacrificing all of its material advantages, the examples hereinbefore described merely being preferred or exemplary embodiments of the invention.

What is claimed is:

1. An electronic device to convert data to universal asynchronous receiver/transmitter (UART) signals suitable to be transmitted via an audio port of the electronic device, wherein each UART signal comprises a start bit represented by a binary number 0, eight data bits, a parity bit and a stop bit represented by a binary number 1, the electronic device comprising:
a storing module to store the data comprising a plurality of bytes;
a reading module to read the plurality of bytes of the data one by one and calculate a parity bit for each byte, wherein each byte is defined as the eight data bits of a corresponding UART signal, the parity bit of each byte is defined as the parity bit of the corresponding UART signal;
an audio register to generate a first audio signal and a second audio signal via the audio port of the electronic device;
a controller to control the audio register to output the first or second audio signal according to the binary numbers of the start bit, the eight data bits, the parity bit and the stop bit of each UART signal so as to covert the data to the UART signals; and
a processor operable to execute operations of the storing module, the reading module, the audio register and the controller.

2. The electronic device as claimed in claim 1, further comprising a determination module to determine whether the plurality of bytes in the storing module have all been converted to the UART signals.

3. The electronic device as claimed in claim 1, wherein the data comprises a failure report and a system log of the electronic device.

4. The electronic device as claimed in claim 1, wherein a signal period of the first or second audio signal is determined by a baud rate of data transmission.

5. A method executed by an electronic device to generate universal asynchronous receiver/transmitter (UART) signals via an audio port of the electronic device, wherein each UART signal comprises a start bit represented by a binary number 0, eight data bits, a parity bit and a stop bit represented by a binary number 1, the method comprising:
reading a byte of a plurality of bytes of data stored in a storing module of the electronic device to be defined as the eight data bits of an UART signal, and calculating a parity bit for the byte to be defined as the parity bit to the UART signal;
outputting a first audio signal via the audio port of the electronic device to represent the start bit of the UART signal;
outputting the first audio signal or a second audio signal via the audio port of the electronic device to represent the eight data bits of the UART signal according to eight binary numbers of the byte successively;
outputting the first or second audio signal via the audio port of the electronic device to represent the parity bit of the UART signal according to the parity bit of the byte;
outputting the second audio signal via the audio port of the electronic device to represent the stop bit of the UART signal;
wherein the first and second audio signals represent the binary numbers 0 and 1, respectively, the byte is converted to the UART signal based on the first audio signal S1 and the second audio signal S2.

6. The method as claimed in claim 5, further comprising:
determining whether the plurality of bytes of the data in the storing module has all been converted to the UART signals; and
if the plurality of bytes of the data has not all been converted to the UART signals, reading the remaining data.

7. The method as claimed in claim 5, wherein the data comprises a failure report, a system log of the electronic device.

8. The method as claimed in claim 5, wherein a signal period of the first or second audio signal is determined by a baud rate of data transmission.
